(19) United States
(12) Patent Application Publication
(10) Pub. No.: US 2016/0053162 A1
(43) Pub. Date: Feb. 25, 2016

(54) METHOD OF MANUFACTURING OF LIGHT CERAMIC PROPPANTS AND LIGHT CERAMIC PROPPANTS

(71) Applicant: BALTIC CERAMICS S.A., Lubsko (PL)

(72) Inventor: MACIEJ MARCHWICKI, ZAGAN (PL)

(21) Appl. No.: 14/778,613

(22) PCT Filed: Dec. 27, 2013
(86) PCT No.: PCT/PL2013/050038

§ 371 Date: Sep. 21, 2015

(30) Foreign Application Priority Data
May 12, 2013 (PL) P.406381

(51) Int. Cl. C09K 8/80; C04B 35/14

(52) U.S. Cl. CPC C09K 8/80; C04B 35/14

(57) ABSTRACT

A method for manufacturing of light ceramic proppants made from a mixture of raw materials that is mechanically granulated in a granulator or that is granulated in a spray dryer from a pourable ceramc mass, to obtain granulate having a granule size of 150-1700 μm (12-100 U.S. Mesh, ASTM E11-04, ISO 13503-2), and next the granulate is fired and the fired granulate is fractioned. The mixture of raw materials is prepared from: illite-beidellite-ka-olinite high-plastic clays of the Poznan series in the amount of 10% to 40% by weight; kaolinite clays in the amount of 10% to 45% by weight; kaolin in the amount of 20% to 40% by weight; fly ash from brown coal combusted in a power plant in the amount of 10% to 35% by weight; and treatment agents in the amount of up to 10% by weight. The mixture of raw materials is mixed and homogenized in a homogenizer, and the obtained granulate is fed to a fluidised bed dryer, in which it is dried to a moisture content below 3%, and the granulate is fired in a rotary furnace in a temperature from 1150° C. up to 1410° C. in time from 120 to 600 min, obtaining proppants which contain from 18% to 32% by weight of Al203, from 40% to 76% by weight of SiO₂, and have a specific gravity from 2.15 Mg/m³ to 2.90 Mg/m³ and a bulk density from 1.35 Mg/m³ to 1.70 Mg/m³, depending on the firing time.

### TECHNICAL FIELD

This present invention relates to a method for manufacturing of light ceramic proppants and light ceramic proppants.

### BACKGROUND ART

Ceramic proppants are used in mining hydrocarbons from conventional and non-conventional sources. Conventional sources are characterized by high permeability of rocks, and they are located about 10 times closer to the ground as compared to non-conventional sources. Therefore, mining hydrocarbons from conventional sources does not pose many problems—sometimes, even a single, shallow vertical bore is enough to proceed with mining. In turn, for non-conventional sources, the bores must be made much deeper, and both vertical and horizontal bores must be made. The non-conventional hydrocarbon sources include crude oil, shale gas, coal bed methane (CMB), gas hydrates and tight gas.

When extracting oil and shale gas, there are employed various methods for stimulation of rocks to improve their conductivity and to enable efficient mining of hydrocarbons. One of the method is a method of hydraulic fracture or of dry fracture is used. In each of these methods, shale rock around a horizontally-drilled hole or vertically-drilled hole are crushed, and then into the borehole there is entered LPG or a liquid with addition of sand or proppants, e.g. ceramic proppants (a granulated ceramic material), wherein the liquid preferably contains pentane in a form of gel suspension containing ceramic proppants. The proppants are added in each method to prevent closing the gaps in crushed shale rocks after reducing the pressure at the end of the fracturing process. The use of ceramic proppants results in better flows of hydrocarbons through the crushed rock and in effect significantly improves the productivity of well bore. In order to effectively mine hydrocarbons, it is necessary for the proppants to have appropriate parameters, which allow using the proppants at the depth of several kilometres—the proppants are typically forced in to depths of about 1000-5000 m.

The essential technical parameters for proppants are: compression strength, sphericity of shape, bulk density, specific gravity. Other important parameters include resistance to acids, permeability (and conductivity associated therewith), as well as turbidity. Each parameter has a particular impact on the quality of proppants, The prerequisite for the application of proppants is their chemical inertness.

Appropriately selected viscosity of liquid and gel is necessary to produce suspension and to transport proppants, however it is limited by the need to achieve an adequate flow of crushing substance into drilled rock fractures. In this situation the specific gravity of proppants is of great importance. The viscosity of liquid in which the proppants are suspended should be selected such that the proppants could be transported into the rock fractures effectively (i.e. as far as possible), and to allow easy removal of the liquid from the bore.

Higher compression strength offers the possibility to use proppants in conditions of higher pressures, i.e. in deeper well bores. The higher the compression strength of the proppants, the lower is the probability that the proppants are crushed inside the fracture, which would be very disadvantageous. Crushing of the material leads to closing the light of the channel, and therefore blocks the possibility for free flow of hydrocarbons. It is desirable for the proppants to have a high compression strength and a low specific gravity.

The value of proppants sphericity coefficient has an effect on the unrestricted flow of gas, which, in turn, affects the gas productivity extracted from the well bore. The average sphericity of quartz sand is 0.7. In turn, the average sphericity of ceramic proppants is 0.9. High sphericity coefficient allows optimal distribution of proppants, which enables free, enhanced flow of hydrocarbons.

The volume of bulk density is a derivative of specific gravity, a sphericity of proppants and their grain size. Similarly to the parameters described above, it induces the quality of proppants and plays an important role mainly during transport of material.

Use of proppants with lower specific gravity and high mechanical strength is preferred due to the fact that they enable to use cheaper liquids of lower viscosity and pumps of lower performance, as well as they enable to use methods of so-called dry fracturing, i.e. with the use of a minimum quantity of water on the basis of the use of LPG, in particular a gel gas-pentane. The additional advantage of proppants having a low specific gravity is the more efficient transport of material during forcing it inside the bore and a better distribution in the preformed fracture. This causes increase of efficiency of hydrocarbons mining.

Due to the value of specific gravity, proppants can be divided into groups of high, medium or low specific gravity.

Sintered bauxite proppants are proppants having a high specific gravity. They include high content of Aluminium oxide Al₂O₃ and are characterised by a high compression strength. The raw materials are ground, granulated and calcined. The content of Al₂O₃ reaches up to 83%, the specific gravity is above 3.5 Mg/m3. They are suitable for use in borewell of depths up to about 5000 m.

Their high specific gravity makes it difficult to transport the material into the fracture, and sometimes leads to closing the light of the fractures, which is caused by excess accumulation of bauxite proppants in a particular area.

Traditional proppants of average specific gravity are suitable for use in the depths up to about 3500 m and have a specific gravity from about 3.10 to 3.45 Mg/m3. The content of Al₂O₃ ranges from 40% to 32%.

The proppants of a low specific gravity have been described in US patents U.S. Pat. No. 4,522,731 and U.S. Pat. No. 5,120,455. For the production of light proppants, kaolinite clays containing approx. from 40% to 60% of Al₂O₃ are used and the specific gravity of the proppants is less than 3.0 Mg/m3.

Other light proppants have been described in a US patent U.S. Pat. No. 7,036,591. The main component to form the lightweight proppants described therein is kaolin. The content of Al ₂O₃ is from 32% to 40%, and the specific gravity of the proppants ranges from 1.60 to 2,10 Mg/m3. This specific gravity is obtained as a result of a special short cycle firing in a temperature from 1200 to 1350° C., causing a formation of a strong sinter, mainly on the surface of proppants.

A Russian patent publication RU2392295 discloses ceramic proppants, which are made from the following main components: aluminosilicates, bauxite, kaolin and residual products of aluminium oxide production. These proppants are fired in a temperature from 1000 to 1550° C. in a rotary furnace, and the obtained proppants have a specific gravity from 1.30 to 3.00 Mg/m³ and a size from 0.2 to 4.00 mm.

A US patent application US20120118574 discloses a method for manufacturing ultralight ceramic proppants of large strength with the use of raw materials obtained from the regions of Wanyao, Ningde and Fuan, Fuijan province, China. These ultralight ceramic proppants are made of the following raw materials: porcelain clay (5-85% by weight), kaolin and/or calcined fireclay (5-85% by weight) and plastic ceramic clay (5-30% by weight). These raw materials have a long history in China. They were and are used for the production of ceramic whiteware such as tableware, urns, ornamental elements, and for the production of ceramics used in industry, such as fire-bricks and different ceramic products used in metallurgy. The materials obtained by that procedure are characterized by the content of Al₂O₃ from 5.5 to 35% by weight (preferably, 14-25%), SiO₂—content of 69.5-89.5% by weight (preferably 69.5-81.5%). These ultralight proppants have the following main parameters: specific gravity of 2.10-2.55 Mg/m³, bulk density of 1.30-1.50 Mg/m³, sphericity of 0.8-0.9. The compression strength for various fractions is the following:
40/70—less than 5% at 7500 psi, less than 10% at 10000 psi,
30/50—less than 10% at 7500 psi, less than 15% at 10000 psi,
20/40—less than 15% at 7500 psi, less than 20% at 10000 psi.
   These ultralight ceramic proppants are fired in a rotary furnace in the temperature of 1150-1380° C. for 75-960 minutes.

Each raw materials source is geologically distinct and therefore requires appropriate selection of technological process parameters for the particular type of raw material. When producing ceramic proppants, the main parameters include temperature and time of firing, technological devices parameters, as well as appropriate selection of the output mix of raw materials, dependent on the particular raw material.

The light ceramic proppants currently available on the market have a strength of about 10000 psi. Tests have shown a relatively high percentage of fines (small pieces of crushed proppants) that negatively impact the parameters of the proppants, i.a. by significant decrease of their conductivity. In addition, the specific gravity increases along with the strength, which is also economically disadvantageous. The higher specific gravity of proppants causes the need to use more expensive fracturing liquids, and moreover it hampers efficient and deep positioning of proppants in rock fractures.

### OBJECT OF THE INVENTION

Therefore, it would be expedient to develop light ceramic proppants, as well as a method for manufacturing thereof, that would be characterised by a high strength and a low specific gravity, high sphericity, and which can be manufactured from raw materials available in Europe, especially in Poland and Germany.

The object of the invention is a method for manufacturing of light ceramic proppants made from a mixture of raw materials that is mechanically granulated in a granulator or that is granulated in a spray dryer from a pourable ceramic mass, to obtain granulate having a granule size of 150-1700 μm (12-100 U.S. Mesh, ASTM E11-04, ISO 13503-2), and next the granulate is fired and the fired granulate is fractioned, characterised in that that:
the mixture of raw materials is prepared from:
   illite-beidellite-kaolinite high-plastic clays of the Poznan series in the amount of 10% to 40% by weight;
   kaolinite clays in the amount of 10% to 45% by weight;
   kaolin in the amount of 20% to 40% by weight;
   fly ash from brown coal combusted in a power plant in the amount of 10% to 35% by weight;
   and treatment agents in the amount of up to 10% by weight;
wherein the mixture of raw materials is mixed and homogenized in a homogenizer,
and the obtained granulate is fed to a fluidised bed dryer, in which it is dried to a moisture content below 3%,
and the granulate is fired in a rotary furnace in a temperature from 1150° C. up to 1410° C. in time from 120 to 600 min, obtaining proppants which contain from 18% to 32% by weight of Al₂O₃, from 40% to 76% by weight of SiO₂, and have a specific gravity from 2.15 to 2.90 Mg/m³ and a bulk density from 1.35 to 1.70 Mg/m³, depending on the firing time.

Another object of the invention are light ceramic proppants made from a mixture of clays, characterised in that they are manufactured from a mixture of raw materials consisting of:
illite-beidellite-kaolinite high-plastic clays of the Poznan series in the amount of 10% to 40% by weight;
kaolinite clays in the amount of 10% to 45% by weight;
kaolin in the amount of 20% to 40% by weight;
fly ash from brown coal combusted in a power plant in the amount of 10% to 35% by weight;
and treatment agents in the amount of up to 10% by weight.

Preferably, the mixture of raw materials comprises the following Al₂O₃ content in particular components: illite-beidellite-kaolinite high-plastic clays of the Poznan series, containing from 10% to 27% by weight of Al₂O₃; kaolinite clays, containing from 18% to 32% by weight of Al₂O₃; kaolin, containing from 28% to 40% by weight of Al₂O₃; fly ash from brown coal combusted in a power plant, containing from 5% to 15% by weight of Al₂O₃.

Preferably, the ceramic proppants contain from 18% to 32% by weight of Al₂O₃, and from 40% to 76% by weight of SiO₂.

Preferably, the ceramic proppants have a specific gravity from 2.15 to 2.90 Mg/m³ and a bulk density from 1.35 to 1.70 Mg/m³.

Preferably, the illite-beidellite-kaolinite high-plastic clays contain from 10% to 27% by weight of Al₂O₃.

Preferably, the fly ash from brown coal combusted in a power plant and contain from 5% to 15% by weight of Al₂O₃.

It shall be noted that none of the prior art technologies involve homogenization as an additional step improving mixing of the mixture. Moreover, the known technologies do not involve use of a fluidised bed dryer to dry the granules exiting the granulator. The use of these two elements allows to improve the use parameters of the obtained proppants.

The method according to the invention allows to minimize the loss of raw materials, improves the homogenization of the raw materials, improves the effectiveness of the manufacturing process, minimizes energy usage and allows to obtain product of a better quality. The better homogenization of raw materials leads to obtaining high class ceramic proppants, having high strength, roundness and sphericity, which leads to good conductivity. In addition, in order to pre-dry the proppants before firing, a fluidised bed dryer was used, which evenly reduces the moisture content of the material.

In addition, by using modern technological devices and innovative solutions it is possible to obtain high quality end product with minimized raw material losses.

The use of fly ash from brown coal as an additive allows i.a. to lower the temperature of firing of proppants, and therefore positively impacts the energetic efficiency of the technological process. In addition, the properties of fly ash make it possible to achieve a product of a class higher than standard, i.a. by increase of strength. Moreover, use of residue material positively impacts the environment.

### MODES FOR CARRYING OUT THE INVENTION

### Raw Materials Used

Raw materials used to prepare ceramic mass such as illite-beidellite-kaolin clays, kaolinitic clays and kaolin may come from the south-western Poland (the area of Fore-Sudetic Monocline) or from neighbouring regions, including materials from Germany, in which there are clays of the indicated content of Al₂O₃.

The raw materials used in this invention are characterized by the following content of aluminium oxide:
high-plastic clays of the Poznan series: from 10% to 27% by weight;
kaolinite clays: from 18% to 32% by weight;
kaolin: from 28% to 40% by weight;
fly ash from brown coal combusted in a power plant: from 5% to 15% by weight.

The high plasticity clay of Poznan series plasticise the entire mixture of raw materials, provide better moulding/shaping properties, which leads to a better sphericity factor. This is especially necessary in the stage of mechanical granulation. On the other hand, when fired they are characterised by a high compression strength that reaches the values of more than 70 MPa, i.e. above 10000 psi. This is related to large amounts of vitreous phase in this substrate while firing, with the occurrence of different physical and chemical reactions.

The spectral chemical analysis using XRF method of the high-plastic clays has shown the following chemical content of the major chemical components:

| Chemical | Content |
|---|---|
| component | [%] |
| Al₂O₃ | 10-35 |
| SiO₂ | 57-70 |
| Fe₂O₃ | 0.5-10 |

The analysis of mineral content of high-plasticity clay used to make the ceramic mass has been made using XRD method (X-Ray Diffraction). The table below shows example results:

| Mineral | Content |
|---|---|
| component | [%] |
| Kaolinite | 45-60 |
| Illite | 10-25 |
| Microclin | 5-10 |
| Quartz | 15-40 |

Kaolinite clays are plastic clays of medium plasticity that are used for the production of higher quality building materials. The main minerals forming this type of clays are kaolinite and illite. Their main role in the ceramic mass is to provide components to produce the vitreous phase and a large content of mullite in fired material, which improves strength parameters of the material.

The spectral chemical analysis using XRF method of the kaolinite clay has shown the following chemical content of the major oxides:

| Chemical | Content |
|---|---|
| component | [%] |
| Al₂O₃ | 21-39 |
| SiO₂ | 55-65 |
| Fe₂O₃ | 0.5-2.0 |

Kaolins are the raw materials of low plasticity and therefore for the production of proppants should be used together with other raw materials. In view of the fact that they contain more than 40% Al₂O₃, mainly in the form of kaolinite, their presence in ceramic mass increases strength parameters of proppants.

The spectral chemical analysis using XRF method of kaolin has shown the following chemical content of the major oxides:

| Chemical | Content |
|---|---|
| component | [%] |
| Al₂O₃ | 30-45 |
| SiO₂ | 50-60 |
| Fe₂O₃ | 0.5-3 |

The analysis of mineral content of kaolin used to make the ceramic mass has been made using XRD method (X-Ray Diffraction). The table below shows example results:

| Mineral | Content |
|---|---|
| component | [%] |
| Kaolinite | 60-75 |
| Illite | 8-25 |
| Microclin | 1-15 |
| Quartz | 5-15 |

The main component of the clay materials used is kaolinite. The second clay component is illite, but its content is much lower than that of kaolinite. The non-clay component, present in large amounts, is quarts. The plastic kaolinite clay used to prepare the ceramic mixture makes the mixture plastic, which makes it easier to be formed and allows to make granules of high roundness—exceeding the minimum value of 0,7 for ceramic proppants as defined by the ISO 13503-2:2006/A1 standard. This is an essential and preferable element to be used in mechanical granulation. The other advantage of using the particular type of clay is the crushing strength, which is on average above 10 000 psi. This is due to high content of glass phase present at the treatment phase, which leads to many advantageous physicochemical transformations.

Fly ash from brown coal combused in power plants are characterised by a chemical composition similar to kaolinite clays. Owing to the fact that they are produced at high temperatures, they are strongly vitrificated, which preferably affects the sintering during firing and allows to decrease the firing temperature by about 30-50° C. There are known several types of fly ashes. Depending on the type of combusted fuel, the ashes are classified as fly ashes from hard (bituminous) coal, fly ashes from brown coal or fly ashes fro biomass. The fly ashes differ i.a. by the content of chemical elements, i.e. the content of aluminium, silicon, oxide, carbon, iron, calcium, magnesium, potassium, sulphur etc.

It shall be noted that the chemical content of fly ashes from brown coal is variable and dependent on the type of installation in which the fuel is burnt. Therefore, the content of particular components may differ significantly.

For the present invention it is essential that the fly ashes from brown coal are characterized by Al₂O₃ content from 5% to 15% and relatively low content of CaO.

Method for Manufacturing of Light Ceramic Proppants

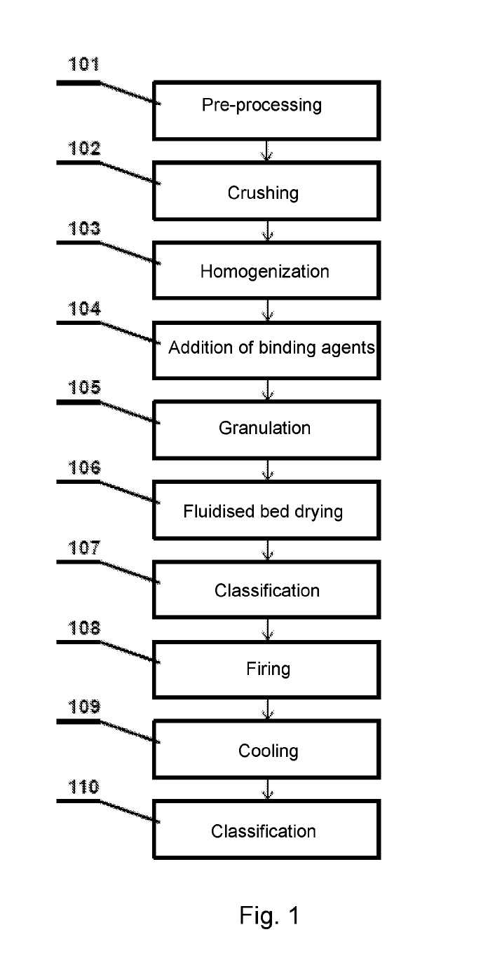

The method to produce light ceramic proppants according to the invention proceeds as shown in FIG. 1. In the first stage 101 of the process, the raw materials are prepared in a roll crusher, jaw crusher or hammer crusher, i.e. they are crushed, preferably to a size below 10 cm. Next, in stage 102 the pre-crushed main raw materials are transferred to a ball mill with a drying function. In this stage two processes are carried out: crushing and drying of raw materials. This is a very important stage, as the components input to the mill have a moisture content of about 15%, which decreases to about 10% at the output of the mill. The raw materials which exit the mill are characterized by the following grain size distribution: d97%<60 μm and d50% 8-15 μm. Furthermore, at this stage the fraction which does not meet the production process requirements is separated, i.e. fraction that is too small (which can be stored for future use) or too large (which is fed back to be crushed).

Next, in stage 103, the crushed raw materials are input to a homogenizer. This stage aims to homogenize the output mixture of materials. Appropriate mixing is important and impacts the useful parameters of the ceramic proppants. Good homogenization is important for the following stage of the process, namely granulation in stage 105.

Granulation, also called pelletization, may be performed using a mechanical or spray technique. Mechanical granulation is performed in series-R mixers provided by EIRICH company or other mixers having similar use parameters. In order to granulate in a spray dryer, a pourable ceramic mass is made having a specific density and viscosity, which loses its moisture in contact with high temperature to form granules.

After the granules are made, the material is transported in step 106 to a fluidised bed dryer. The aim of this step is to dry the granules to obtain moisture content below 3%. Use of this type of drying is aimed to evenly remove moisture from granules, which minimizes the risk of breaking of granules during the firing process. In addition, this type of dryer dries material in an even and quick manner, which improves the effectiveness of the process.

Next, the material is sieved in step 107, i.e. it is classified to eliminate oversize and undersize grains. The proppants obtained by mechanical granulation are characterised by a higher compression strength and a higher specific gravity and bulk density. In the case of granulation by use of a spraying dryer, the obtained proppants are characterized by a lower compression strength, lower bulk density and specific gravity, but they have a higher roundness. The grains which meet the process requirements are passed to a further stage of the process.

In order to allow formation of granules, binding agents are added to the mixture in step 104, which aim to provide good binding properties of the ceramic mass to form aggregates. These agents allow obtaining round grains, so-called green pellets. Selection of an appropriate binding agent and its amount depends on the properties of materials used. The granules exiting the granulator have a grain size of 150-1700 μm (i.e. 12-100 U.S. mesh).

Another processing operation is firing the obtained granulate in step 108 a rotary furnace. In the case of the present invention, the proppants, so-called green pellets, are fired at temperature from 1150° C. to 1410° C., optimally from 1180° C. to 1280° C. The firing time is from 120 to 600 min., optimally from 180 to 480 min.

The firing curve of the ceramic proppants is important, as it can be obtained only in appropriately configured rotary furnace. Due to rotary motion of the furnace around its axis, the material inside is subject to even temperature. The rotary furnace is slightly tilted with respect to horizontal, and therefore the rotated material moves along the furnace. In the first stage it is preheated in a temperature from 150° C. to 350° C. for 30 to 60 minutes, next it is sintered in a temperature from 1150° C. to 1410° C. (optimally, from 1180° C. to 1280° C.) and next it is cooled in a cooler to a temperature below 50° C., optimally from 30° C. to 35° C.

The cooling of fired proppants in step 109 is a very important stage, which minimizes the creation of heat stresses, which lead to decohesion of the material.

After cooling, the proppants are subject to final classification in step 110 to separate them to fractions. Next, the proppants are packed into big bags and/or silos and stored.

An important parameter of the technological process is recuperation of heat generated while the technological process—the recovered and stored heat can be reused for example to preheat or to dry the components in the milling and drying mills.

The light ceramic proppants made from such mixtures of raw materials and in the way described above, achieve specific gravity within 2.15 and 2.90 Mg/m³, and with the more favourable selecting raw materials, even from 2.20 to 2.70 Mg/m³. The bulk density is from 1.35 to 1.70 Mg/m³, and with more favourable selection of the raw materials is between 1.40 and 1.60 Mg/m³. The light ceramic proppants obtained according to the technology described above are characterised by the following strength:
for fraction of 40/70 mesh up to 1.6% crushed at pressure up to 7500 psi, and 2.8% crushed at pressure up to 10 000 psi,
for fraction 30/50 mesh, respectively, up to 1.6% crushed at pressure up to 7500 psi, and up to 2.6% crushed at pressure up to 10 000 psi,
for fraction 20/40 mesh, respectively, up to 0.5% crushed at pressure up to 5000 psi, up to 2.8% crushed at pressure up to 7500 psi, and up to 7.3% crushed at pressure up to 10000 psi.

The solution according to the present invention is distinguished from the solution as described in the US patent application US20120118574, by the fact that other types of clays are used which are available in the south-west Poland and are enriched with kaolin and the addition of fly ash originated from brown coal and other treatment agents. Furthermore, in the technology disclosed in US20120118574 the mixture is not homogenized and no fluidised bed dryer is used. The proppants according to the invention are characterised of a higher content of Al₂O₃ and lower content of SiO₂.

The result of different compositions of raw materials is a difference in the technical parameters of ceramic proppants manufactured according to these recipes. Moreover, in the solution according to the present invention, the longer lower firing time and longer total firing time are applied. Firing in view of the addition of fly ash can be carried out at a lower temperature. It is also possible to use a wider range of temperatures, particularly together with the increase in participation of improvers.

### Exemplary Embodiments of the Invention

### EXAMPLE 1

The ceramic mass containing 30% of Poznan series clays, 40% of kaolinite clays 20% of kaolin and 10% of fly ash from brown coal was prepared as follows. A mixture containing Poznan series clays and kaolinitic clays, was fragmented in a ball mill and next deprived of undersize and oversize particles. In the next step, it was mixed in a homogenizer and granulated in a granulator, the granulate size of 40/70 mesh. The granulate dried in a fluidised bed dryer was fired in a rotary furnace at temperature of 1280° C. The whole process resulted in proppants containing: 27.0% Al₂O₃, 65.0% SiO₂, Fe₂O₃ 3.1%, CaO 2.2%, K₂O+Na₂O 2.1%, other 0.6%. Tests of the proppants have shown specific gravity 2.42 Mg/m³, bulk density 1.41 Mg/m³, crushing strength 1.5% at 7500 psi and 2.6% at 10000 psi. The roundness was above 0.9 and sphericity was similar.

### EXAMPLE 2

The same ceramic mass as in Example 1 was granulated by using a spraying dryer up to size of 40/70 mesh and fired in a rotary furnace at temperature of 1280° C. In order to make a pourable mass having appropriate rheological parameters, the mixture of materials was supplemented with appropriate amount of water and fluidizer. Tests of the proppants have shown: specific gravity 2.41 Mg/m³, bulk density 1.40 Mg/m³, crushing strength 1.6% at 7500 psi and 2.8% at 10000 psi. The roundness was 0.9 and sphericity was also 0.9.

### EXAMPLE 3

The ceramic mass containing 40% of Poznan series clays, 40% of kaolinite clays, 20% of kaolin and 10% of fly ash from brown coal was prepared in the same way as in Example 1. After crushing and mixing in a homogenizer, it was granulated in a granulator, the granulate size of 40/70 mesh. The granulate dried in a fluidised bed dryer was fired in a rotary furnace at a temperature of 1250° C. The whole process resulted in proppants containing: 26.9% Al₂O₃, 65.0% SiO₂, Fe₂O₃ 3.2%, CaO 2.2%, K₂O+Na₂O 2.1%, other 0.6%. Tests of the proppants have shown specific gravity 2.40 Mg/m³, bulk density 1.38 Mg/m³, crushing strength 1.5% at 7500 psi and 2.7% at 10000 psi. The roundness was above 0.9 and sphericity was also above 0.9.

### EXAMPLE 4

The same ceramic mass as in Example 3 was granulated by using a spraying dryer up to a size of 40/70 mesh and fired in a rotary furnace at temperature of 1250° C. The tests of the proppants have shown specific gravity 2.39 Mg/m³, bulk density 1.37 Mg/m³, crushing strength 1.6% at 7500 psi and 2.8% at 10000 psi. The roundness was 0.9 and sphericity was 0.9.

1. A method for manufacturing of ceramic proppants, the method comprising:
preparing a mixture of raw materials comprising:
illite-beidellite-kaolinite high-plastic clays of the Poznan series in the amount of 10% to 40% by weight, containing from 10% to 27% by weight of Al₂O₃;
kaolinite clays in the amount of 10% to 45% by weight, containing from 18% to 32% by weight of Al₂O₃;
kaolin in the amount of 20% to 40% by weight, containing from 28% to 40% by weight of Al₂O₃;
fly ash from brown coal combusted in a power plant in the amount of 10% to 35% by weight, containing from 5% to 15% by weight of Al₂O₃;
and treatment agents in the amount of up to 10% by weight;
mixing the mixture of the raw materials
homogenizing the mixture of the raw materials in a homogenizer to obtain a homogenized mixture,
granuting the homogenized mixture to a granulate having a granule size of 12-100 Mesh (ASTM E11-04 ISO 13503-2).
drying the granulate in fluidised bed dryer to reduce moisture content below 3%,
and firing the granulate in a rotary furnace in a temperature from 1150° C. to 1410° C. for a time from 120 to 600 min, to obtain proppants which contain from 18% to 32% by weight of Al₂O₃, from 40% to 76% by weight of SiO₂, and have a specific gravity from 2.15 Mg/m³ to 2.90 Mg/m³ and a bulk density from 1.35 Mg/m³ to 1.70 Mg/m³, depending on the time of firing.

2. Ceramic proppants made from a mixture of raw materials consisting of:
illite-beidellite-kaolinite high-plastic clays of the Poznan series in the amount of 10% to 40% by weight, containing from 10% to 27% by weight of Al₂O₃;
kaolinite clays in the amount of 10% to 45% by weight, containing from 18% to 32% by weight of Al₂O₃;
kaolin in the amount of 20% to 40% by weight, containing from 28% to 40% by weight of Al₂O₃;
fly ash from brown coal combusted in a power plant in the amount of 10% to 35% by weight, containing from 5% to 15% by weight of Al₂O₃;
and treatment agents in the amount of up to 10% by weight.
wherein the ceramic proppants contain from 18% to 32% by weight of Al₂O₃, and from 40% to 76% by weight of SiO₂ and have a specific gravity from 2.15 Mg/m³ to 2.90 Mg/m³ and a bulk density from 1.35 Mg/m³ to 1.70 Mg/m³.

3. (canceled)

4. The light ceramic proppants according to claim 2, characterized in that the ceramic proppants contain from 18% to 32% by weight of Al₂O₃, and from 40% to 76% by weight of SiO₂.

5. The light ceramic proppants according to claim 2(-4), characterized in that the ceramic proppants have a specific gravity from 2.15 Mg/m³ to 2.90 Mg/m³ and a bulk density from 1.35 Mg/m³ to 1.70 Mg/m³.

6. The light ceramic proppants according to claim 2-, characterized in that the illite-beidelite-kaolinite high plastic clays contain from 10 to 27% by weight of Al₂O₃.

7. The light ceramic proppants according to claim 2-, characterized in that the fly ash from brown coal combusted in a power plant and contain from 5 -15% by weight of Al₂0₃.

8. Ceramic proppants prepared by a process comprising:
preparing a mixture of raw materials from:
illite-beidellite-kaolinite high-plastic clays of the Poznan series in the amount of 10% to 40% by weight, containing from 10% to 27% by weight of Al₂O₃;
kaolinite clays in the amount of 10% to 45% by weight, containing from 18% to 32% by weight of Al₂O₃;
kaolin in the amount of 20% to 40% by weight, containing from 28% to 40% by weight of Al₂O₃;
fly ash from brown coal combusted in a power plant in the amount of 10% to 35% by weight, containing from 5% to 15% by weight of Al₂O₃;
and treatment agents in the amount of up to 10% by weight;
mixing the mixture of the raw materials,
homogenizing the mixture of the raw materials in a homogenizer to obtain a homogenized mixture,
granulating the homogenized mixture to a granulate having a granule size of 12-100 Mesh (ASTM E11-04, ISO 13503 - 2),
drying the granulate in a fluidised bed dryer to reduce moisture content below 3%,
and firing the granulate in a rotary furnace in a temperature from 1150° C. to 1410° C. for a time from 120 to 600 min, to obtain proppants which contain from 18% to 32% by weight of Al₂O₃, from 40% to 76% by weight of SiO₂, and have a specific gravity from 2.15 Mg/m³ to 2.90 Mg/m³ and a bulk density from 1.35 Mg/m³to 1.70 Mg/m³, depending on the time of firing.
